(19) United States
(12) Patent Application Publication
(10) Pub. No.: US 2026/0225169 A1
(43) Pub. Date: Aug. 6, 2026

(54) DEVICE AND METHOD FOR ELECTROCHEMICAL MACHINING

(71) Applicant: MTU Aero Engines AG, München (DE)

(72) Inventors: Kilian Bayer, Gerolsbach (DE); Christian Doll, Ainhofen (DE)

(73) Assignee: MTU Aero Engines AG, München (DE)

(21) Appl. No.: 19/138,455

(22) PCT Filed: Dec. 15, 2022
(86) PCT No.: PCT/DE2022/100959

§ 371 Date: Jun. 12, 2025

(51) Int. Cl. B23H 7/28; B23H 9/10

(52) U.S. Cl. CPC B23H 7/28; B23H 9/10

(57) ABSTRACT

The present invention relates to a device for machining a component by means of electrochemical machining, the device comprising a machining cathode for electrochemically removing material from the component, a component holder for holding the component during the machining, and a positioning unit for moving the machining cathode relative to the component holder. The component holder and the positioning unit are movable relative to each other in a penetration direction of the machining cathode, the machining cathode is additionally laterally movable by means of the positioning unit, i.e., at an angle to the penetration direction and the positioning unit has a linear drive, by means of which the lateral movability is implemented.

### BACKGROUND OF THE INVENTION

The present invention relates to a device for machining a component by electrochemical machining.

In electrochemical machining, a working gap is adjusted between the component and the tool, with the component then being typically polarized as the anode and the tool as the cathode. On account of the insofar contact-free machining, it is also possible to machine relatively hard materials by removal of material, as a result of which the method can be used advantageously for the manufacture of components for axial turbomachines, in particular aircraft engines. Against this background, special requirements ensue in regard to the precision or reproducibility of the component machining. This is intended to illustrate a preferred sphere of application, but not to initially limit the present subject in terms of its generality.

### SUMMARY OF THE INVENTION

The present invention is based on the technical problem of specifying an advantageous device for machining a component by electrochemical machining.

This problem is solved in accordance with the invention by use of the device according to claim 1. In this device, a component holder, in which the component for the machining is arranged, and a positioning unit with the machining cathode are movable relative to each other initially in a penetration direction. In this penetration direction, the machining cathode is successively moved into the component during machining; that is, the component holder and the machining cathode are moved towards each other. Furthermore, the machining cathode is additionally laterally movable by the positioning unit, that is, at an angle to the penetration direction. This lateral movability is implemented here by a linear drive of the positioning unit, by which the machining cathode is moved laterally with a translational movement during the component machining.

In comparison to an alternatively conceivable approach, in which a rotational movement would be converted to a lateral movement by way of a cam and a corresponding suspension, the linear drive can be of advantage in that, for example, the lateral movement can be decoupled from other movement components. It is thereby possible, for example, to simplify the layout of the process-oriented operating material (for example, freeform surface design), because no linked track movements need to be taken into consideration. The decoupling from the penetration movement can also be of advantage during operation, for example, such as when it is necessary, for instance, to retract the machining cathode in the event of a disruption, it being possible to simplify this when no multiaxially linked tract movement needs to be taken into consideration. In addition, the relative movement in the penetration direction and the lateral movement additionally produced by way of the linear drive can also be implemented more simply on the control side.

Preferred embodiments are found in the independent claims and in the total disclosure, whereby a distinction is not always made in detail in the description of the features between device and method aspects or use aspects; in any case, the disclosure is to be read implicitly in terms of all claim categories. If, for example, a suitable machining device is described for a specific operation, it is to be understood at the same time as a disclosure of a corresponding operating method and vice versa.

In relation to the penetration direction, the lateral movement is “angled”; that is, the movement track implemented by the linear drive can also be situated in general obliquely or preferably perpendicularly to the penetration direction. The relative movability of the component holder and the positioning unit in the penetration direction can be implemented by a corresponding movement unit, with which, as viewed in a fixed coordinate system, it is possible during machining to move the positioning unit in the penetration direction towards the component holder or else to move the component holder towards the positioning unit with the machining cathode (and, during retraction of the machining cathode, in the opposite direction in each instance). Preferably, as viewed in the fixed coordinate system, the positioning unit is at rest in relation to the penetration direction; that is, the component holder/the component are moved, preferably being lowered vertically downwards towards the machining cathode during machining.

As explained in the introduction, the machining cathode is preferably polarized as the cathode; the component machining as such can occur, for example, in a so-called ECM process (electrochemical machining, ECM), but, in particular, also in a PEM process (precise electrochemical machining) or PECM process (pulsed electrochemical machining). An advantage of the linear drive can also lie, for example, in the fact that it is hereby possible to adjust quite different oscillation shapes—for example, as need be, a trapezoidal or sinusoidal shape—or to overlap the lateral movement.

In general, the linear drive can also be implemented, for example, mechanically or piezoelectrically, although, in a preferred embodiment, it is provided as a linear motor. This linear motor has a stator and a runner, which can move along the stator in accordance with the magnetic field principle (pushed or pulled along the track by repeated reversals of polarity). The linear motor, which can also be referred to as a “linear direct drive” on account of its compact design, can be readily integrated. In addition, it can be used to implement a force sensing in a relatively finely sensitive manner, thereby reducing the risk of collisions. In comparison to a hydraulic drive, for instance, it is possible to reduce the energy consumption and, in addition, in the event of leakage, the hydraulic fluid could also contaminate the electrolytes (downtime/costs), for example. A hydraulic drive, in comparison to the linear motor, for example, can also place increased requirements on the control or electric regulation, which, in turn, means expense once again (area, costs, and energy).

In general, for example, the lateral movement of the machining cathode can be coupled to the runner by way of a gearbox/a deflection rod; in a preferred embodiment, however, the machining cathode is arranged on the runner, that is, is directly mounted on it. This can reduce the number of components, for example, that is, can result in an overall simplified construction, which, accordingly, is less prone to disruption.

Generally, the path of travel along which the runner can move on the stator is preferably a straight line over the entire movement track. Regardless thereof, in a preferred embodiment, the runner is held on the movement track on the stator in a form-fitting manner preferably over the entire movement track. In relation to directions, this form fit is hereby perpendicular to the movement track; that is, the runner is held perpendicular to the movement track on the stator at a defined distance, which, for example, can allow a good precision.

In a preferred embodiment, the guide has a rod, which passes through the runner in a direction parallel to the movement track. The runner can slide along the movement track on the rod, which is preferably linear (straight) over at least this length. Preferably, the guide has, in addition a second rod, which likewise surrounds the runner and which is parallel to the first rod.

In accordance with a preferred embodiment, the machining cathode is mounted by way of a quick-release chuck on the positioning unit, preferably on the runner. This can enable a fast retrofit when, for instance, a machining cathode with a different contour is required or when the machining cathode has reached the end of its service life and needs to be replaced. The quick-release chuck can, for example, comprise one centering pin or a plurality of centering pins, on which the mounted machining cathode is placed in alignment.

In accordance with a preferred embodiment, the device has, in addition to the (first) machining cathode, a second machining cathode, which can be moved laterally by use of a second positioning unit (at an angle to a second penetration direction). The second positioning unit, too, has a (second) linear drive, which, in turn, is preferably a linear motor. All of the preceding statements made generically for the “machining cathode” and the “positioning unit” relate, first of all, to the first machining cathode and positioning unit, but are intended explicitly to be disclosed as well in regard to the embodiment of the second machining cathode and positioning unit. Preferably, the first and second positioning units are identical to each other in terms of design.

In general, the first penetration direction of the first machining cathode can also be at an angle to the second penetration direction of the second machining cathode; that is, during machining, the cathodes could penetrate the component at an angle to each other. In a preferred embodiment, however, this penetration occurs in a parallel manner; that is, the first and second penetration directions coincide.

In accordance with a preferred embodiment, the first and second positioning units are provided in such a way that the movement track of the first linear drive lies on a common straight line and/or on two collinear tracks with the movement track of the second linear drive. In relation to the recess that is introduced by way of the penetration of the electrodes into the component, the first electrode can then be moved during machining (additionally to the penetration), with the first positioning unit being moved towards a first flank bounding the recess and the second machining cathode with the second positioning unit being moved towards a second flank, which likewise bounds the recess and is opposite-lying to the first flank.

The invention also relates to a method for machining a component by electrochemical machining, whereby material is removed electrochemically by use of a machining cathode and the component and the machining cathode are moved relative to each other in a penetration direction. Furthermore, by use of a positioning unit on which the machining cathode is arranged, the machining cathode is laterally moved (at an angle, in particular perpendicular, to the penetration direction). This lateral movement is adjusted by a linear drive of the positioning unit, preferably a linear motor.

Preferably, this method is implemented on a presently disclosed device. In regard to possible details, reference is made to the preceding discussions.

In a preferred embodiment, the component that is to undergo machining by material removal is a component for a turbomachine, in particular for an aircraft engine. Especially preferably, the component can involve a so-called blisk (blade integrated disk), that is, a disk with blades formed on it integrally (monolithically). By way of the machining by material removal, the gaps between the blades or airfoils are exposed (and the blades remain).

### BRIEF DESCRIPTION OF THE DRAWINGS

The invention is described below in detail on the basis of exemplary embodiments, whereby the individual features in the scope of the dependent claims can be of essence to the invention also in other combinations and, furthermore, a distinction is not made in detail between the different claim categories.

Shown in detail are

FIG. 1 shows a device for machining a component by electrochemical machining;

FIGS. 2A, 2B show a detailed view of a positioning unit of the device in accordance with FIG. 1;

FIG. 3 shows an aircraft engine in a schematic longitudinal cross section.

### DESCRIPTION OF THE INVENTION

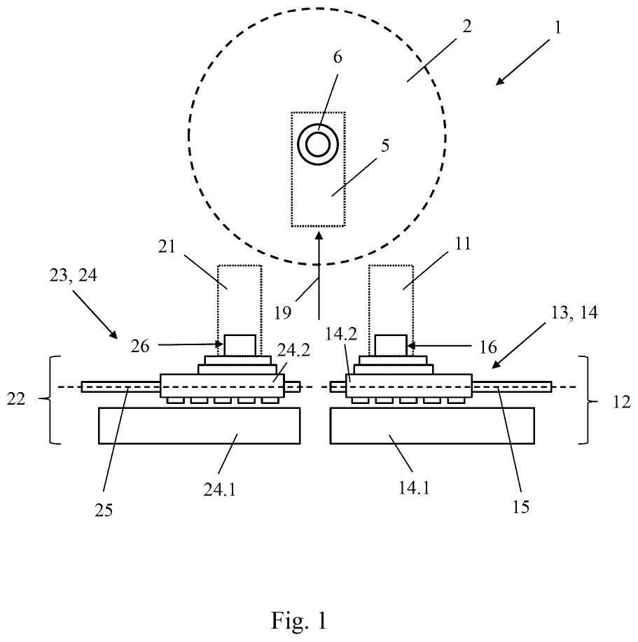

FIG. 1 shows a device 1 for machining a component 2 by electrochemical machining, for which purpose the device 1 has a (first) machining cathode 11, which is arranged on a (first) positioning unit 12 having a (first) linear drive 13, which is designed as a linear motor 14. By use of the positioning unit 12, the machining cathode 11 can be moved laterally along a movement track 15, namely, perpendicular to a (first) penetration direction 19. A relative movement between the component 2 and the machining cathode 11 is implemented by lowering the component 2 by use of a movement unit 5 (illustrated only schematically), by which the component holder 6 and thus the component 2 are lowered and hence the machining cathode 11 can penetrate in the penetration direction 19. As described in detail in the introductory description, the lateral movement that is produced by way of the linear drive 13 is decoupled from the latter; that is, no complicated deflection gear, etc. is required.

Furthermore, the device 1 has a second machining cathode 21, which is mounted on a second positioning unit 22 with a second linear drive 23, specifically a linear motor 24. The second movement track 25 lies on a straight line with the first movement track 15. The two linear motors 14, 24 each have a stator 14.1, 24.1 and a runner 14.2, 24.2, which can move on the stator 14.1, 24.1 in accordance with the magnetic field principle. The machining cathodes 11, 21 are each mounted on the respective runner 14.2, 24.2, namely, by way of a respective quick-release chuck 16, 26.

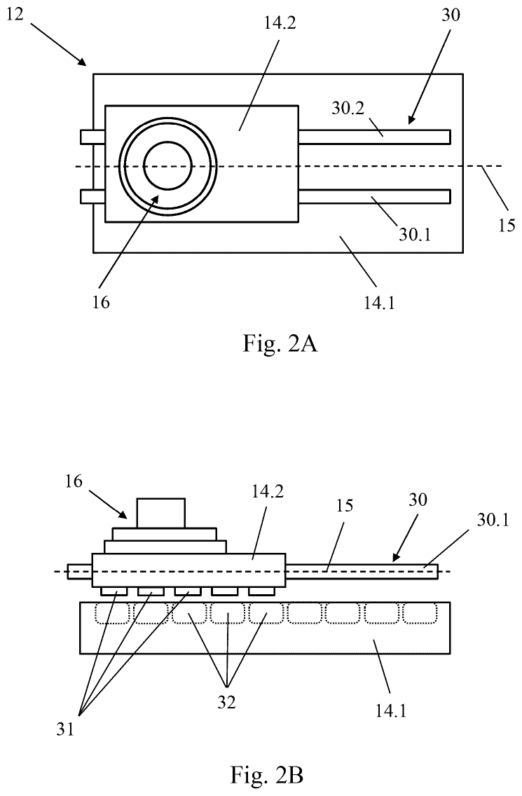

FIGS. 2A, 2B show the (first) positioning unit 22 in detail (the second positioning unit is analogous in design), namely, in a view from the top and in a side view. The runner 14.2 is held in a form-fitting manner on a guide 30, which has a first and second linear rod 30.1, 30.2. The rods 30.1, 30.2 pass through the runner 14.1, which can slide along the movement track 15 on the rods 30.1, 30.2. Arranged on the bottom side of the runner 14.1 are magnets 31, by which it can be moved by corresponding reversal of polarity along the magnets 32 of the stator 14.2, which are shown only schematically.

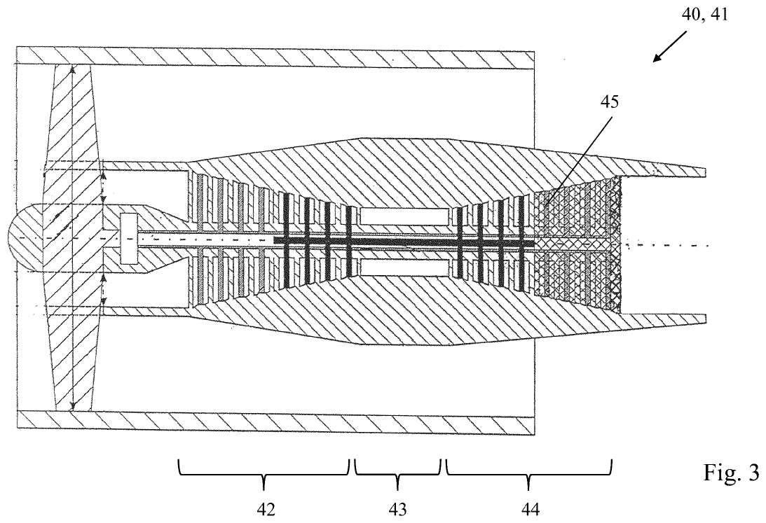

FIG. 3 shows a turbomachine 40, which, in the present case, is an aircraft engine 41. It is divided functionally into a compressor 42, a combustion chamber 43, and a turbine 44. During operation, air intake is compressed in the compressor 42 and undergoes combustion with admixed kerosene in the downstream combustion chamber 43, whereby the hot gas that is formed undergoes expansion in the turbine 44. Both the compressor 42 and the turbine 44 each have a plurality of stages with guide vane cascades and rotating blade cascades, whereby, for example, a rotating blade cascade, referenced here by way of example with the reference sign 45, of the turbine 44 can be designed as a blisk.

1. A device for machining a component by electrochemical machining, comprising:
a machining cathode configured and arranged for the electrochemical removal of material from the component,
a component holder configured and arranged for the holding of the component during the machining, and
a positioning unit configured and arranged for the movement of the machining cathode relative to the component holder,
wherein the component holder and the positioning unit are moved relative to each other in a penetration direction of the machining cathode,
wherein the machining cathode with the positioning unit is additionally moved laterally at an angle to the penetration direction, and
wherein the positioning unit has a linear drive (13), by which its lateral movability is implemented.

2. The device according to claim 1, wherein the linear drive is a linear motor configured and arranged as a runner which moves along a stator in accordance with the magnetic field principle.

3. The device according to claim 2, wherein the machining cathode is arranged on the runner.

4. The device according to claim 2, which is configured and arranged to measure a force by electric power applied for moving the runner the force being applied with the movement of the runner.

5. The device according to claim 2, wherein the runner is held on a guide in a form-fitting manner on its movement track along the stator, in directions perpendicular to the movement track.

6. The device according to claim 5, wherein the guide has a rod that surrounds the runner.

7. The device according to claim 1, wherein the machining cathode is mounted on the positioning unit by a quick-release chuck in a reversible manner.

8. The device according to claim 1, further comprising:
a second machining cathode, and
a second positioning unit for the movement of the second machining cathode relative to the component holder,
wherein the component holder and the second positioning unit is moved relative to each other in a second penetration direction of the second machining cathode,
wherein the second machining cathode with the second positioning unit is moved laterally, that is, at an angle to the second penetration direction,
and wherein the second positioning unit has a second linear drive, by which its lateral movability is implemented.

9. The device according to claim 8, wherein the first and second positioning units are moved jointly relative to the component holder and the first and second penetration directions coincide.

10. The device according to claim 8, wherein a movement track of the second linear drive lies on a straight line with a movement track of the first linear drive.

11. A method for machining a component by electrochemical machining, wherein a machining cathode is used for the electrochemical removal of material from the component,
moving the component and the machining cathode relative to each other in a penetration direction of the machining cathode, and
by use of a positioning unit on which the machining cathode is arranged, moving the machining cathode laterally by a linear drive of the positioning unit at an angle to the penetration direction.

12. The method according to claim 11, wherein a device is used to carry out the method which comprises:
a machining cathode configured and arranged for the electrochemical removal of material from the component,
a component holder configured and arranged for the holding of the component during the machining, and
a positioning unit configured and arranged for the movement of the machining cathode relative to the component holder.
wherein the component holder and the positioning unit are moved relative to each other in a penetration direction of the machining cathode,
wherein the machining cathode with the positioning unit is additionally be moved laterally at an angle to the penetration direction, and
wherein the positioning unit has a linear drive, by which its lateral movability is implemented.

13. The method according to claim 11 wherein the component is a component for a turbomachine.

14. The method according to claim 13, wherein the component is a blisk.

15. A method for the manufacture of a component, wherein the component is machined by a method according to claim 11.
